(19) United States
(12) Patent Application Publication
(10) Pub. No.: US 2007/0124203 A1
(43) Pub. Date: May 31, 2007

(54) Systems and methods for marketing programs segmentation

(75) Inventors: Eugenia Popescu, Toronto (CA); Ioan Popescu, Toronto (CA)

Correspondence Address: BERESKIN AND PARR, 40 KING STREET WEST, BOX 401, TORONTO, ON, M5H 3Y2, CA

(73) Assignee: EU & I Software Consulting Inc., Toronto (CA)

(21) Appl. No.: 11/376,221

(22) Filed: Mar. 16, 2006

Related U.S. Application Data
(60) Provisional application No. 60/740,287, filed on Nov. 29, 2005.

(51) Int. Cl. G06Q 30/00

(52) U.S. Cl. 705/14

(57) ABSTRACT

Systems and methods for method of measuring the efficiency of a plurality of marketing programs for a campaign involving a plurality of saleables and at least one distribution channel. The steps of the methods include: determining a plurality of marketing program segments, wherein each segment corresponds to a unique combination of marketing programs; uniquely correlating each combination of a saleable and distribution channel to a corresponding segment; determining the quantity of at least one measurable for each saleable; and calculating an efficiency value for at least one segment. The systems include a segmentor operatively coupled to a data storage and configured to determine a plurality of marketing program segments, wherein each segment corresponds to a unique combination of marketing programs. The systems also include a correlator operatively coupled to the data storage and configured |to | correlate each combination of a saleable and distribution channel to one marketing program segment; and an efficiency calculator configured to calculate an efficiency value for at least one segment.

### CONTINUITY

This application is a continuation of U.S. patent application No. 60/740,287 filed Nov. 29, 2005 which is incorporated by reference herein in its entirety.

### FIELD OF THE INVENTION

The present invention relates generally to the field of marketing, with common but by no means exclusive application to evaluating the efficiency of marketing programs. As used herein, the term “marketing program” and as will be understood should be interpreted broadly and includes the advertising or promotional medium or methods like direct mail, telemarketing, space advertising, radio and television commercials, price reduction, gifts, awards, prizes or commemoratives.

### BACKGROUND OF THE INVENTION

There is a growing need for businesses to justify their marketing expenditures. Businesses must evaluate the responses to different marketing programs, in order to determine if their marketing dollars are being spent wisely. Businesses need to know which elements of their advertising plan helped achieve their goals in the most efficient manner and which did not, in order to be able to allocate their budgets on an ongoing basis.

Typically, marketing “success” has been measured in the context of the following types of analyses:
A. Existence: Proof of Advertising Performance, which tracks the delivery of advertising;
B. Effectiveness: Return on Objective (ROO), which examines marketplace response to advertising; and
C. Efficiency: Return on Investment (ROI) or Return on Marketing Investment (ROMI), which measures the relative efficiency of various marketing tactics (such as advertising/promotion mix, media mix, etc.).

Advances in technology have allowed more complex data to be analyzed. Techniques such as marketing mix modeling were introduced in the 1990s and have expanded in scope to meet the increased ROI measurement demand for marketers. Marketing mix modeling is a statistical technique based primarily on pattern recognition. This analysis compares week-by-week, market-by-market patterns in advertising and marketing elements to patterns in sales. When matching patterns are located, conclusions are drawn about the positive (or negative) effect the advertising elements had on their corresponding sales. Marketing mix modeling techniques include, but are not limited to, multiple regression analysis, logistic regression, neural net analysis, and genetic algorithm analysis. A marketing mix model is a specialized version of an econometric model.

The inventors have recognized a need for alternative systems and methods for evaluating the efficiency of marketing programs.

### SUMMARY OF THE INVENTION

In a first aspect, the present invention is directed towards a method of measuring the efficiency of a plurality of marketing programs for a campaign involving a plurality of saleables and at least one distribution channel. The steps of the method include: determining a plurality of marketing program segments, wherein each segment corresponds to a unique combination of marketing programs; uniquely correlating each combination of a saleable and distribution channel to a corresponding segment; determining the quantity of at least one measurable for each saleable; and calculating an efficiency value for at least one segment.

In another aspect, the present invention is directed towards a system for measuring the efficiency of marketing programs. The system includes a data storage configured to store: marketing programs data comprising data corresponding to a plurality of marketing programs; saleables data correlated to a plurality of saleables, wherein at least one saleable is correlated to at least one marketing program; and measurables data correlated to the value of sales for each saleable. The system also includes a segmentor, a correlator and an efficiency calculator. The segmentor is operatively coupled to the data storage and configured to determine a plurality of marketing program segments, wherein each segment corresponds to a unique combination of marketing programs and wherein the data storage is configured to store marketing program segment data correlated to the marketing program segments. The correlator is operatively coupled to the data storage and configured to correlate each saleable to one marketing program segment. The efficiency calculator is configured to calculate an efficiency value for at least one segment.

### BRIEF DESCRIPTION OF THE DRAWINGS

The present invention will now be described, by way of example only, with reference to the following drawings, in which like reference numerals refer to like parts and in which:

FIG. 1 is a schematic diagram of a marketing programs efficiency system made in accordance with the present invention.

FIG. 2 is a schematic diagram of example marketing program records data as may be stored in the marketing program data storage entity of the system of FIG. 1;

FIG. 3 is a schematic diagram of example campaign data 25 as may be stored in the campaign data storage entity of the system of FIG. 1,

FIG. 4 is a schematic diagram of example saleables data as may be stored in the saleables data storage entity of the system of FIG. 1;

FIG. 5 is a schematic diagram of example location data which may be stored in the location data storage entity of the system of FIG. 1;

FIG. 6 is a schematic diagram of example association data as may be stored in the association data storage entity of the system of FIG. 1;

FIG. 7 is a schematic diagram of example measurables data typically stored in the measurables data storage entity of the system of FIG. 1;

FIG. 8 is a schematic diagram of example marketing program segment data records as may be determined and stored in the program segment data storage entity by the system of FIG. 1;

FIG. 9 is a schematic diagram of example segmented saleables data records as may be generated and stored in the segmented saleables data storage entity by the system of FIG. 1;

FIG. 10 is a schematic diagram of example segmented measurables data as may be generated and stored in the segmented measurables data storage entity by the system of FIG. 1;

FIG. 11 is a flow diagram illustrating the steps of a method of the present invention.

FIG. 12 is a schematic diagram illustrating the potential plurality of relationships between saleables and marketing programs in raw data.

FIG. 13 is a schematic diagram illustrating the unique relationship between each saleables and a corresponding segmented marketing program once the marketing program segments have been determined and associated with the raw data in accordance with the method of the present invention.

FIG. 14A is a schematic diagram illustrating a ROMI efficiency calculation report as may be generated by the system of FIG. 1.

FIG. 14B is a schematic diagram illustrating an alternate efficiency calculation report as may be generated by the system of FIG. 1.

### DETAILED DESCRIPTION OF THE INVENTION

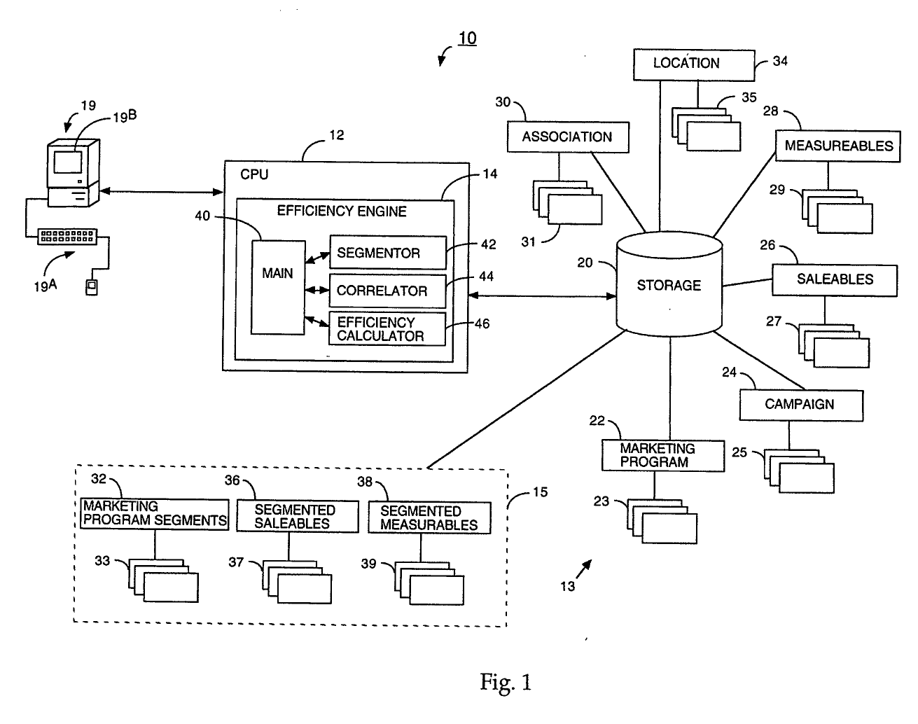

Referring to FIG. 1, illustrated therein is a marketing programs efficiency system, referred to generally as 10, made in accordance with the present invention. The system 10 comprises a processor or central processing unit (CPU) 12 such as a standard personal computer (PC) running on a WINDOWS™ operating system and having a suitably programmed efficiency engine 14. As will of course be understood, other types of suitable hardware and operating systems may be used.

An input/output device 19 (typically including an input component 19^{A} such as a keyboard, and output components such as a display 19^{B}) is also operatively coupled to the CPU 12.

Data storage 20 is also provided, although as will be understood, the storage 20 may be local to or remote from the CPU 12 and portions of the data stored may be stored in different physical or electronic storage locations. The data storage 20 will preferably include a marketing program data storage entity 22 storing marketing program data records 23, a campaign data storage entity 24 storing campaign data 25, a saleables data storage entity 26 storing saleables data 27, a measurables data storage entity 28 storing measurables data 29, an association data storage entity 30 storing association data 31. If the company or other entity utilizing the system 10 has multiple stores or other centres of operation, the data storage 20 may also include a location data storage entity 34 storing location data 35. As will be understood, much of the sales and campaign data 23, 25, 27, 29, 31, 35 may be previously generated or collected by marketing or other systems and communicated to or extracted by the system 10 (such communicated or extracted data referred to generally herein as raw data 13).

The data storage 20 will also preferably include a marketing program segment data storage entity 32 storing marketing program segment data 33, a segmented saleables data storage entity 36 storing segmented saleables data records 37, and also a segmented measurables data storage entity 38 storing segmented measurables data records 39 (collectively referred to herein as segmented data 15).

The efficiency engine 14 may include several modules. A main executable module 40 is preferably provided for controlling the operation of the various sub-modules: a segmentor module 42, a correlator module 44, and an efficiency calculator module 46. As will be discussed in greater detail below, the segmented measurables data records 39 and segmented marketing program data records 37 will typically be generated by the segmentor module 42 and the correlator module 44 using the raw data 13.

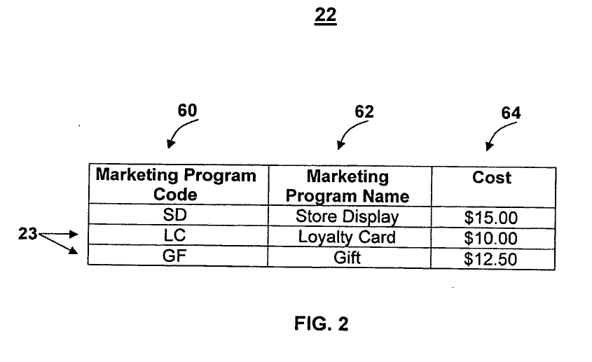

Referring now to FIG. 2, illustrated therein is an example of the type of marketing program records 23 data typically stored in the marketing program data storage entity 22. While the sample data in FIG. 2 for simplicity only illustrates three marketing program records 23, typically the system 10 will be capable of handling complex data involving dozens or more of different marketing programs 23. The marketing program records 23 data may be input into the marketing program data storage entity 22 by a system 10 user, and updated as new marketing programs are implemented or old marketing programs are discontinued.

Each marketing program record 23 will typically include a unique marketing program identifier 60, as well as a marketing program name 62 corresponding to the different marketing programs which may have been implemented in the various marketing campaigns. The marketing program records may also store costing data 64. Typically the costing data 64 corresponds to the cost per saleable 27 of the marketing program 60. In the example data, marketing programs such as a store display (with a per saleable cost 64 of $15), a loyalty card points promotion (with a per saleable cost 64 of $10) or a gift promotion (with a per saleable cost 64 of $12.50) are illustrated, but as will be understood, other types of marketing programs may be used such as media advertising, promotional events, etc.

It should also be understood that the example marketing program records 23 illustrate simplified data for illustrative purposes. As will be understood, the costing data 64 may vary by campaign 25 (for example, a more expensive gift may be provided through a gift promotion 23 during some campaigns 25 than others). Accordingly, a more complicated marketing program record 23 may also include a campaign identifier.

As well, depending on the number and hence complexity of the various marketing programs, it should be understood that a marketing program record 23 may represent a collection of subsidiary promotions—for example, the store display program record 23 may represent a collection of specific display programs such as shelf displays, aisle displays and store-front window displays etc. Similarly, while separate marketing program records may be created for a radio advertisement promotion and a newspaper advertisement promotion, in appropriate circumstances (such as the size of the respective promotions) it may be helpful to combine such promotions into a single marketing program record 23 for “advertisements” generally.

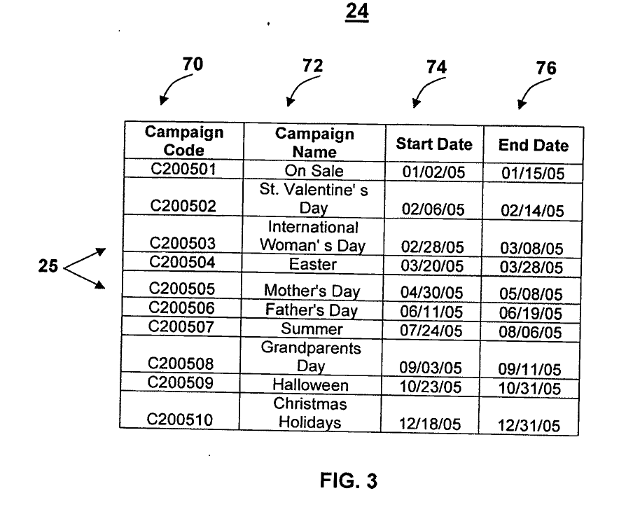

Referring now to FIG. 3, illustrated therein is an example of the type of campaign data 25 typically stored in the campaign data storage entity 24. In the example data shown in FIG. 3, only ten different campaign records 25 are illustrated. However, the system 10 will preferably be configured to implement and track a more expansive data set involving dozens or hundreds or more such campaigns 25. The campaign records 25 data may be input into the campaign data storage entity 24 by a system 10 user, and updated as new campaigns are implemented.

Each campaign record 25 will typically include a unique campaign identifier 70, as well as data corresponding to the campaign name 72, such as “Mother's Day” or “Easter”. Typically, the campaign records 25 will also include other data relating to the implementation of each campaign, such as the campaign start 74 and end 76 dates. Typically, no two campaigns will overlap.

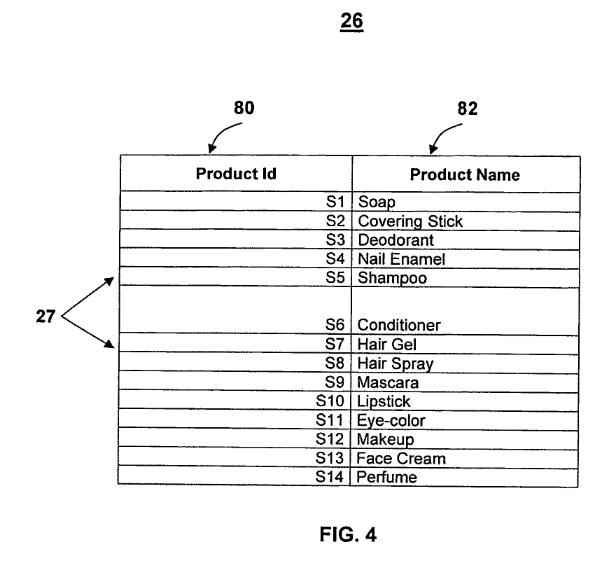

Referring now to FIG. 4, illustrated therein is an example of the type of saleables data 27 typically stored in the saleables data storage entity 26. While the sample data in FIG. 4 illustrates fourteen different saleables 27, the system 10 will preferably be configured to handle and store a more complicated data set involving hundreds or thousands or more of saleables 27. The saleables records 27 data may be input into the saleable storage entity 26 by a system 10 user, and updated for each new saleable. Typically the saleables data 27 includes a unique saleables identifier 80 together with data corresponding to the saleable name 82. As will be understood, the term “saleables” as used herein is intended to refer broadly to goods or services or other intangibles that a company may sell or provide. Preferably, the saleables data 27 will include an entry for each saleable in the company's entire inventory or eligible for promotion. The saleables identifier 80 will preferably correspond to the company's saleable identifier such as a stock keeping unit number (SKU#).

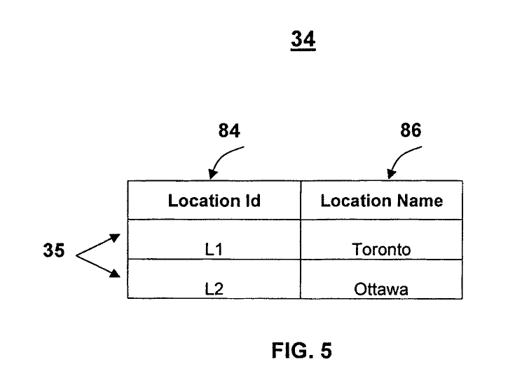

Turning to FIG. 5, illustrated therein is an example of the type of location data 35 which may be stored in the location data storage entity 34. The example data in FIG. 5 illustrates two different location data records 35. As will be understood, the system 10 will preferably be configured to handle and store a more expansive data set involving hundreds or thousands or more of locations 35 or other distribution channels (including without limitation such as the Internet, or direct mailing). The location records 35 data may be input into the location data storage entity 34 by a system 10 user, and updated for each new location. A unique location identifier 84 will preferably be provided, together with data corresponding to the location name 86.

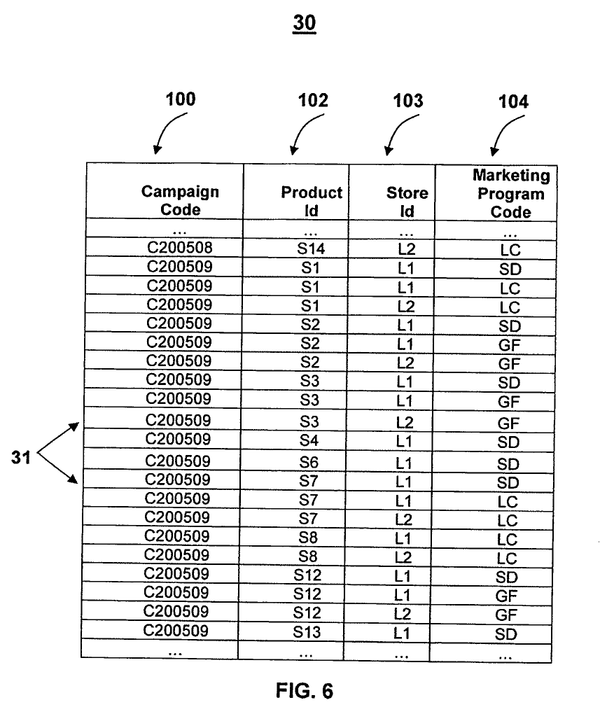

Referring now to FIG. 6, illustrated therein is an example of the type of association data 31 typically stored in the association data storage entity 30. The association records 31 data may be input into the association storage entity 30 by a system 10 user, and updated for each new campaign. Typically the association data 31 includes a campaign identifier 100 corresponding to the campaign identifiers 70 in the campaign records 25. The association data 31 will typically also include saleables identifiers 102 corresponding to the saleables identifiers 80 stored in the saleables data records 27.

For marketing programs involving multiple locations, the association data 31 may also include location identifier data 103 corresponding to the location identifiers 84 in the locations data records 35 together with a marketing program identifier 104 corresponding to the marketing program identifiers 60 in the marketing programs records 23. As will be understood, if the marketing programs 23 in a campaign 25 do not apply at the distribution channel level (eg. location 35), then the user may elect not to include distribution channel data such as the location identifier data 103 in the association data 31. For example, if all of the marketing programs 23 apply to all of the locations 35 in a campaign 25, then it may not required to include a location identifier data 103 in the association data records 31.

As shown in the example data record 31′ in FIG. 6 (while simultaneously cross-referencing the data in FIGS. 2, 3 and 4), for the Halloween campaign (campaign identifier 70, 100=“C200509”), the covering stick (saleable identifier 80, 102=“S2”) was sold in the Toronto store (location identifier 84, 103=“L1”) in association with the store display and gift marketing program (marketing program identifiers 62, 104=“SD” and “GF”), and also in the Ottawa store (location identifier 84, 103=“L2”) in association with just the gift marketing program (marketing program identifier 62, 104=“GF”).

As will be understood, typically, for every campaign 70, 100, an association record 31 is created for each marketing program 104 (and location 103 combination, if applicable) that a saleable 102 is marketed in association with.

As will be understood, marketing programs may be selectively applied to saleables 102 through different locations 103 or other saleable distribution channels. Accordingly, if a saleable 102 is marketed with two different marketing programs 104 (in only one location 103) during a particular campaign 100, then two association records 31 will preferably be created.

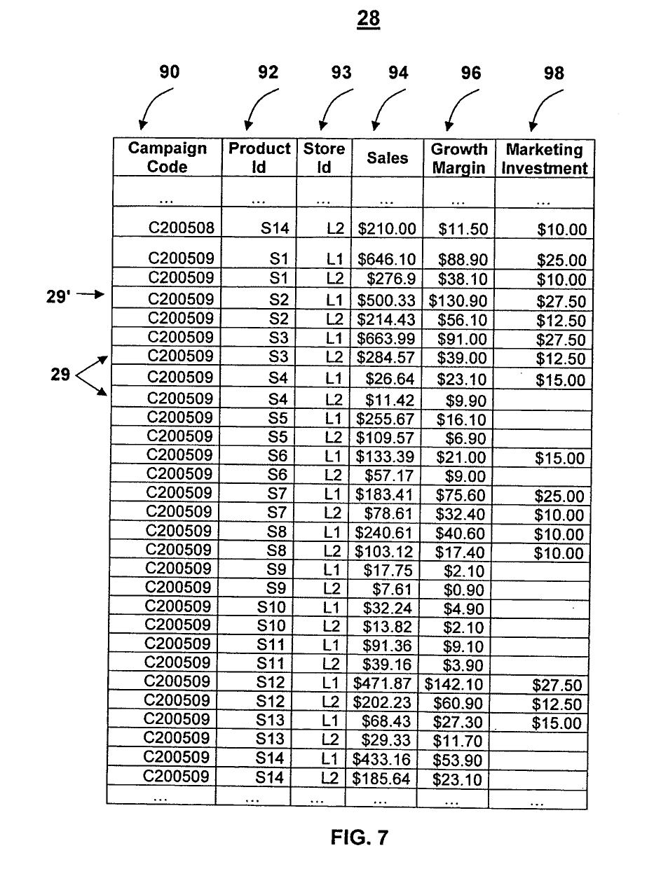

Referring now to FIG. 7, illustrated therein is an example of the type of measurables data 29 typically stored in the measurables data storage entity 28. The measurables records 29 data may be input into the measurable storage entity 28 by system 10 user, and updated for each new campaign, The measurables data 29 preferably includes a campaign identifier 90 corresponding to the campaign identifiers 70 in the campaign data storage entity 24. The measurables data 29 will typically also include a saleables identifier 92 corresponding to the saleables identifier 80 stored in the saleables data records 27.

As noted previously, for corporations or other entities distributing and tracking saleables from multiple locations, the measurables data 29 may also include location identifier data 93 corresponding to the location identifiers 84 in the locations data records 35. The measurables data 29 will also include quantity data 94 typically referred to as “sales” correlated to the value or quantity of each saleable 92 sold or charitable funds received (eg. for a charity application) during the corresponding campaign 90. Typically, the quantity data 94 will be represented in currency, such as dollars, but it should be understood that for some applications, the quantity data 94 may correspond to other measurements, such as number of units sold, cost, price, inventory etc.

The measurables data 29 will preferably also include growth margin data 96 correlated to the increase (or lack thereof) in value or quantity of saleables 92 sold during the campaign 90 relative to pre-campaign sales. As will be understood, the growth margin data 96 is intended to reflect the improvement to “sales” which may be attributed to the campaign 90. Preferably the measurables data 29 will include marketing program investment data 98. The marketing program investment data 98 reflects the total of the marketing program costs 64 of all the marketing programs 104 for a saleable 92 at a particular location 86.

Referring to the example measurables data record 29′ in FIG. 7 (in conjunction with the data in FIGS. 2, 4 & 6), it can be seen that during the Halloween campaign (campaign identifier 70, 90=“C200509”), the covering stick (saleable identifier 80, 92=“S2”) was sold in the Toronto store (location identifier 93, 103=“L1”) in association with the store display and gift marketing program (marketing program identifiers 62, 104=“SD” and “GF”), with a quantity value (representing sales) 94 of $500.33. The example marketing investment data 98 for the example record 29′ indicates a marketing program investment of $27.50, which was determined by adding the store display per saleable cost 64 of $15 to the gift marketing program per saleable cost 64 of $12.50 ($15+$12.50=$27.50). As will be understood the marketing program investment data 98 may either be calculated by the system 10 by adding the appropriate cost data 64 together, or may be previously compiled by marketing or other systems and communicated to or extracted by the system 10.

While the example measurables data records 29 indicate that each saleable 27/92 is sold through each distribution channel 35/93, it should be understood that in some implementations, it may not be the case that a saleable 27 is sold through every distribution channel 35. In such instance, the measurables data storage 28 may only include a measurables data record 29 corresponding to each combination of a saleable 27/92 and a distribution channel 35/93 in which the saleable 27 is distributed through such distribution channel 35.

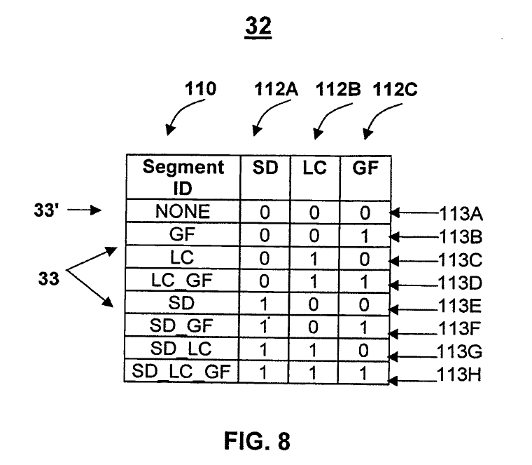

Referring now to FIG. 8, illustrated therein is an example of the type of marketing program segment data records 33 typically stored in the program segment data storage entity 32. Typically, the program segment data 33 includes a unique program segment identifier 110 together with Boolean data 112A, 112B, 112C corresponding to each marketing program 60.

As will be understood, a marketing program segment data record 33 has been created for each possible combination of marketing programs 60, including a “None” record 33′ in which the segment 110 includes none of the marketing programs 60. As can be seen, the Boolean data 112A, 112B, 112C indicates whether the corresponding marketing program 60 is present in the marketing program segment 110.

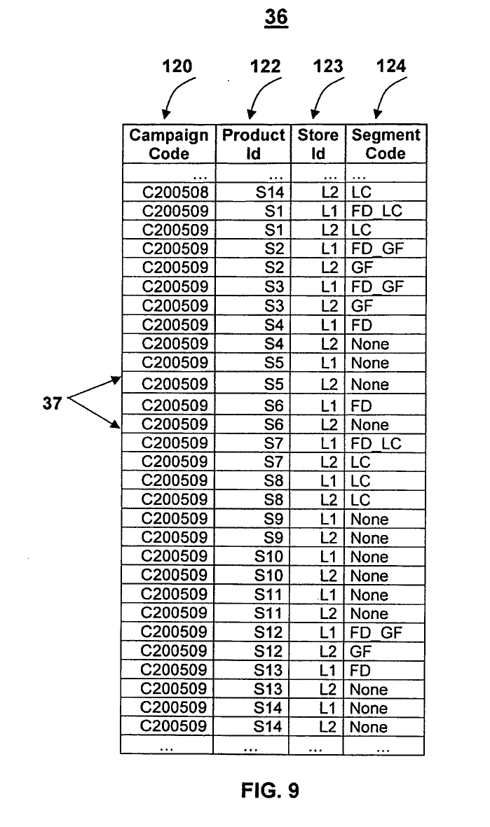

Referring now to FIG. 9, illustrated therein is an example of the type of segmented saleables data records 39 typically stored in the segmented saleables data storage entity 38. Typically, the segmented saleables data 39 includes a campaign identifier 120 corresponding to campaign identifiers 70 in the campaign records 25. The segmented saleables data 39 will typically also include saleables identifiers 122 corresponding to the saleables identifiers 80 stored in the saleables data records 27, together with a location identifier 123 corresponding to the location identifiers 84 in the locations data records 35. A marketing program segment identifier 124 corresponding to the marketing program segment identifiers 110 in the marketing program segment data records 33 is also provided.

One segmented saleables data record 39 is preferably created for each saleable 92/location 93 combination in the measurables data storage entity 28. Each such saleable 122, 92/location (or other distribution channel) 123, 93 combination is uniquely associated with a corresponding marketing program segment 124, 110, correlated to all of the marketing programs 60 applied to the saleable 122 at that location 103 as will be discussed in greater detail below.

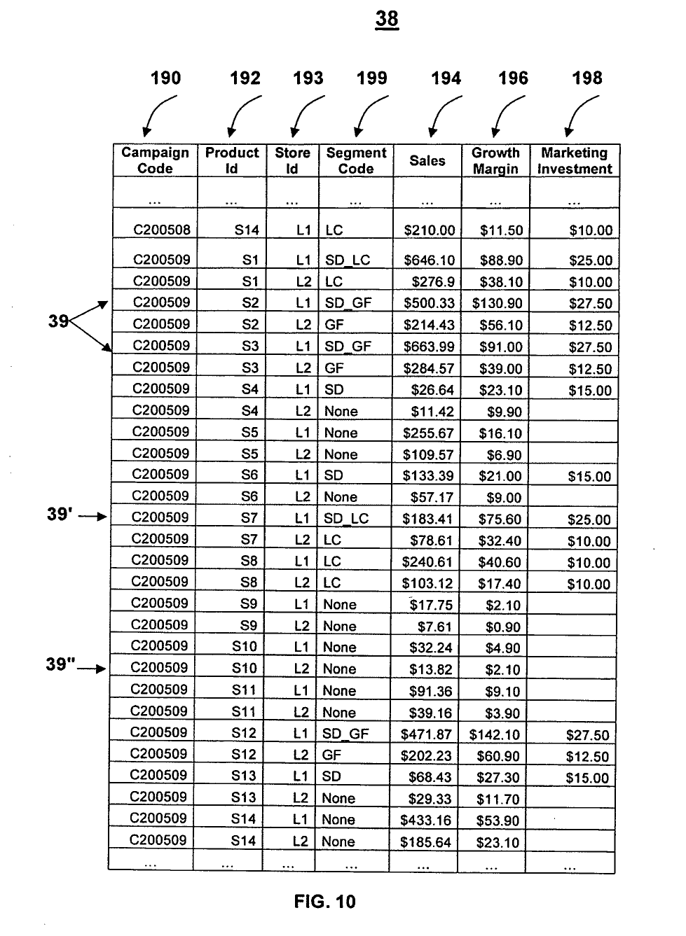

Referring now to FIG. 10, illustrated therein is an example of the type of segmented measurables data 39 typically stored in the segmented measurables data storage entity 38. The segmented measurables data 39 typically corresponds to the measurables data 29 and as a result may include campaign identifier 190, saleables identifier 192, location identifier data 193, quantity data 194, growth margin data 196, and marketing investment data 198 corresponding to the similarly named data 90, 92, 93, 94, 96, 98 in the measurables data records 29, respectively. In addition, the segmented measurables data 39 preferably includes a marketing program segment identifier 199 corresponding to the marketing program segment identifiers 110 in the marketing program segment data records 33.

Referring to the example segmented measurables data record 39′ in FIG. 10 (in conjunction with the data in FIGS. 2, 4, 6 & 8), it can be seen that during the Halloween campaign (campaign identifier 70, 190=“C200509”), the hair gel (saleable identifier 192, 80=“S7”) was sold in the Toronto store (location identifier 193, 103=“L1”) in association with the store display and loyalty card marketing programs (marketing program segment identifier 199, 110=“SD_LC”), with a quantity value (representing sales) 194 of $183.41. The example marketing program investment data 198 for the example record 29′ indicates a marketing program investment of $25.00, together with a growth margin 196 of $75.6.

Another example segmented measurables data record 39″ indicates that during the Halloween campaign (campaign identifier 70, 190=“C200509”), the lipstick (saleable identifier 192, 80=“S10”) was sold in the Ottawa store (location identifier 193, 103=“L2”) without the use of any marketing program (marketing program segment identifier 199, 110=“none”), with a quantity value (representing sales) 194 of $13.82. The example data 39″ also indicates that the sales of the lipstick had a growth margin of $2.1, with no marketing program investment 198 (which is consistent with the absence of marketing programs 199).

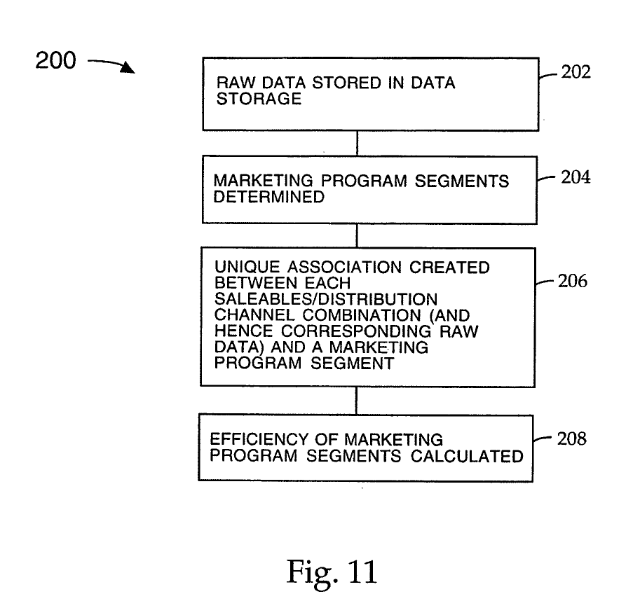

Referring now to FIG. 11, this figure is a flow chart setting out the process 200 carried out by the system 10. Initially, the system 10 receives the raw data 13 and stores it in the data storage (Block 202). As previously noted, the raw data 13 which comprises the majority of the sales and campaign data 23, 25, 27, 29, 31, 35 may be previously generated or collected by marketing or other systems and communicated to or extracted by the system 10. However, it should be understood that the system 10 may comprise part of a larger sales system, in which case the system 10 may not require the step 202 of duplicating such data.

The segmentor 42 determines the marketing program segments 110 (Block 204). The segmentor 42 may do this by accessing the marketing program data records 23 to determine the number, N, of marketing programs 60 utilized by the various marketing campaigns 70. The segmentor 42 may then determine the number of different combinations of marketing programs 60. As will be understood, the number of different possible combinations of marketing programs 60 (and hence marketing program segments 110) is 2^{N}.

Thus, in the example marketing program data 23 illustrated in FIG. 2, three different marketing programs 60 are illustrated (“Store Display”, “Loyalty Card” and “Gift”). Accordingly, based on the example data 23 the segmentor 42 would determine there are 2³=8 potential combinations of marketing programs 60 (including an empty combination, “None”, with no marketing program 60), and may create the program segment data records 33. As will be understood, each marketing program segment 33 may be determined by utilizing Boolean vector data representing values from 0 to 2^{N}−1 (in binary) and illustrating each possible combination with “1”s and “0”s. In the example provided by FIG. 8 the Boolean vector data 113A, 113B, 113C, 113D, 113E, 113F, 113G, 113H have the values: “000”, “001”, “010”, “011”, “100”, “101”, “110”, and “111”, respectively.

Each column of Boolean data 112A, 112B, 112C corresponds to each marketing program 60, and each “1” is a flag indicating that the corresponding marketing program 60 is present in the program segment 33 (and conversely, each “0” is a flag indicating that the corresponding marketing program 60 is not present in the particular program segment 33). With the exception of “None”, each segment identifier 110 preferably corresponds to a concatenation of marketing program identifiers 60 present in the segment 33, but other appropriate identifiers 110 may also be used.

Once the program segments 33 have been determined, the correlator 44 will create an association between the segments 33 and the saleables (Block 206). Effectively, this provides an association between the marketing program segments 33 and the raw data 13 and particularly the measurables data 29.

One approach the correlator 44 may be programmed to perform this task is by utilizing the association data 31 in the association data storage entity 32 (together with the saleables data 23 and the location data 35, if applicable) to generate and store the segmented saleables data 37 in the segmented saleables data storage entity 36. For each saleable 27 (or saleable 27/location 35 combination) for a campaign 100, the correlator 44 may create a segmented saleables data record 37. By scanning the marketing program identifiers 104 in the association data 31 for each saleable 27, 102 (or saleable 27, 102/location 35, 123 combination) the correlator 44 may determine the unique marketing program segment identifier 110 which correlates to each of the marketing programs 104 applied to the saleable 27, 102 (or saleable 27, 102/location 35, 123 combination) and save the marketing program segment identifier 110, 124 in the corresponding segmented saleables data record 37. If no marketing program 104 exists for a saleable 27, 102 (or saleable 27, 102/location 35, 123 combination), then the marketing program segment identifier 110, 124 is determined to be “None”, as will be understood (referred to herein as a “non-marketing program segment”).

Referring briefly to the sample association data 31 in FIG. 6, it can be seen that the saleable 102 and location 103 combination “S7” and “L1” respectively has two corresponding association records 31, each indicating a marketing program identifier 104 “SD” and “LC”, respectively. A corresponding segmented saleables record 37′ for the saleable 102 and location 103 combination “S7” and “L1” has been created in which the marketing program segment identifier 124 has been saved as “SD_LC”.

The correlator 44 may be programmed to then generate and store the segmented measurables data 39 in the segmented measurables data storage entity 38. By matching each saleable 122 and location 123 combination in the segmented saleables data records 37 to corresponding saleable 92 and location 93 combinations in the measurables data records 29, corresponding segmented measurables data records 39 may be created and stored, each including the corresponding segment identifier 124, 199.

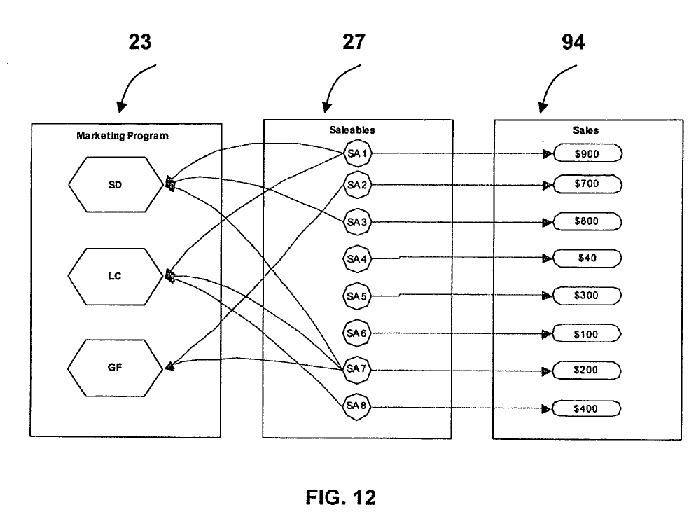

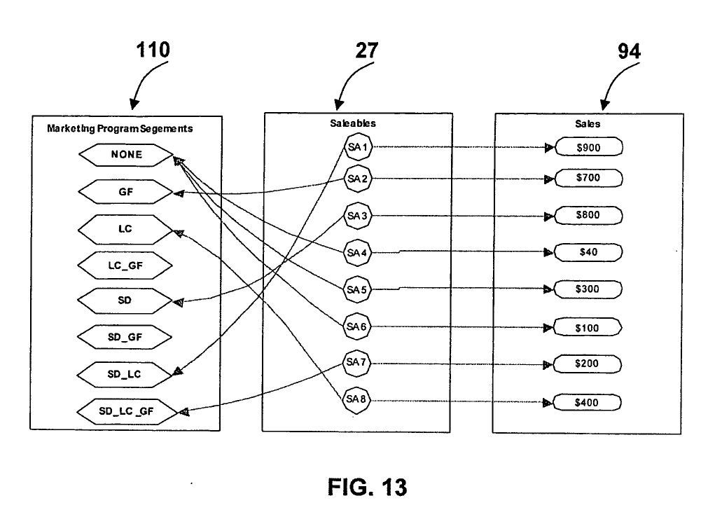

Turning briefly now to FIGS. 12 and 13, illustrated therein are schematic diagrams contrasting the potential one-to-many relationships between each of a plurality of saleables 27 and three unsegmented marketing programs 23 (FIG. 12) which have been used in a campaign 25 as may exist in raw data 13 supplied to the system 10, and the one-to-one relationship between each saleable 27 and the segmented marketing programs 110 (FIG. 13) once the marketing program segments 110 have been determined and associated with the saleables 27 following Blocks 204 and 206.

For the sake of simplicity in the illustrations, the saleables data 27 illustrated in FIGS. 12 and 13 represents data for a company having a single “location” (or possibly for which the measurables data 29 has not been separated by location), and hence does not include location data 35. Alternatively, as noted, each saleable in the schematic diagrams (FIGS. 12 & 13) may represent a unique combination of a saleable 27 and location 35 (or other distribution channel).

As can be seen in FIG. 12, the saleable 27 identified as “SA1” has a plurality of relationships to marketing programs 23 as it is illustrated as having links to both the “SD” and “LC” marketing programs 23, indicating that it has been marketed under both programs 23. FIG. 13 illustrates the same “SA1” saleable 27 following the segmentation and association steps of blocks 204 and 206, having a single relationship to a marketing program segment 110, “SD_LC”.

Referring again to FIG. 11, once the marketing program segments 33 have been determined and associated with the measurables data 29 as set out in Blocks 204 and 206, the system 10 calculates the efficiency of the marketing program segments 33 (Block 208).

To determine the efficiency of the segments 33, the efficiency calculator module 46 may be programmed to determine the quantity of sales for each saleable 27 (or saleable 27 and location 35 (or other distribution channel) combination), which data can be retrieved from the sales data 194 of the segmented measurables records 39.

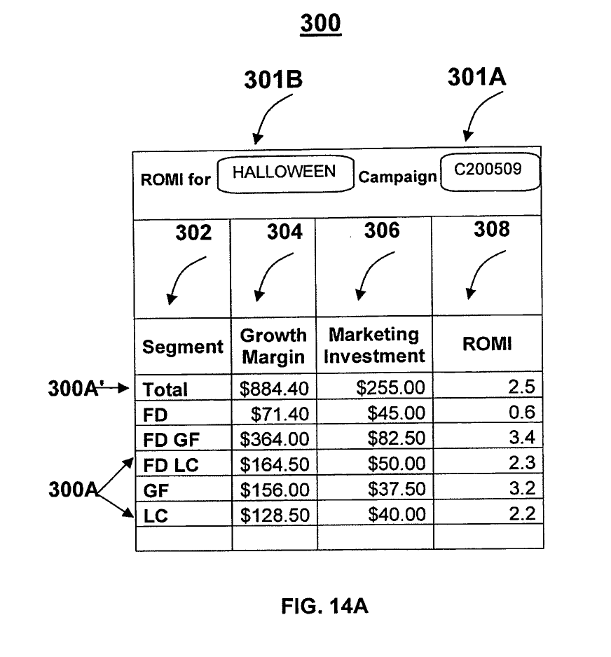

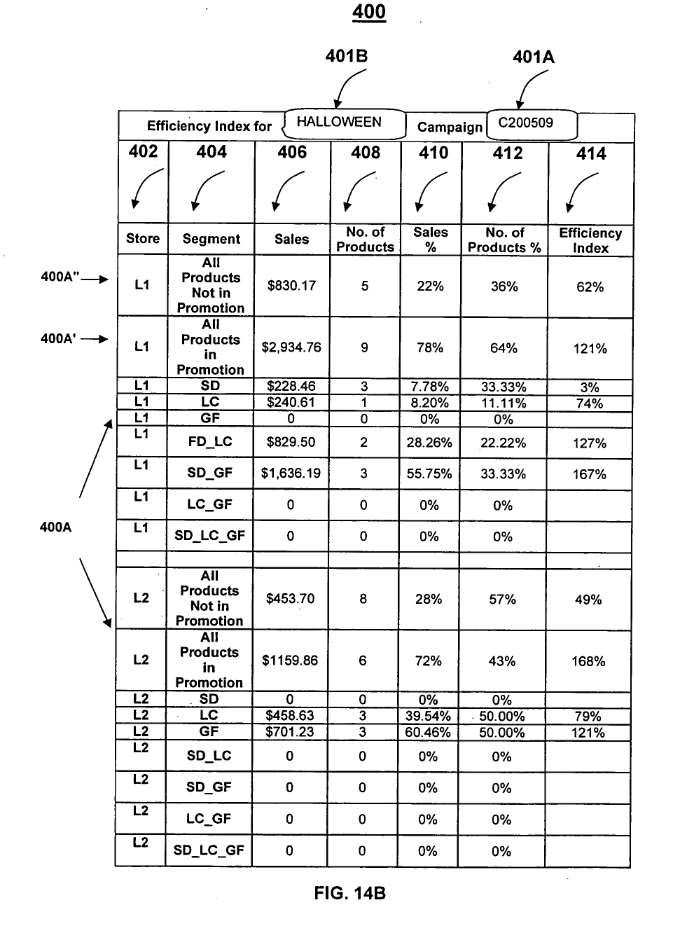

FIG. 14A illustrates an example efficiency report 300 for a campaign 25 containing line entries 300A based on ROMI as may be generated by the efficiency engine 14. Such a report 300 will preferably include a campaign identifier 301 which may include a campaign code 301A and/or a campaign name 301B corresponding to a campaign identifier 70 and campaign name 72, respectively, in the campaign data records 25.

The report 300 will also preferably be provided with a segment identifier 302. Typically, the segment identifiers 302 will correspond to the segment identifiers 110, in the marketing program data records 33. The report 300 may also include an entry 300A′ having a “Total” segment identifier 302 corresponding to efficiency calculations for all saleables 27 sold in association with at least one marketing program 23 (ie. for all saleables 27, 192 (or saleable 27, 102/location 35, 123 combination) other than those indicating a “None” segment identifier 199 in the segmented measurables data records 39). As will be understood, typically the report 300 will include one entry 300A corresponding to each marketing program segment 33, 199 listed on the segmented measurables data storage entity 32 (other than the “None” segment 33′).

Each entry 300A will also preferably include a growth margin value 304 typically determined by summing the growth margin data 196 from each segmented measurables data record 39 for the campaign 190, 401A in which the segment identifier 199 corresponds to the segment identifier 302 for the entry 300A. Similarly, a marketing investment value 306 will preferably be provided and typically determine by summing the marketing investment data 198 from each segmented measurables data record 39 for the campaign 190, 401A in which the segment identifier 199 corresponds to the segment identifier 302 for the entry 300A.

A ROMI efficiency value 308 for each entry 300A is also preferably determined and provided. To calculate the ROMI values 308 for the example ROMI efficiency report 300 entries 300A, the efficiency engine 14 may utilize the following equation (EQ. 1) in which GM represents growth margin 304 and MPI represents marketing investment 306:

$$ROMI = \frac{GM - MPI}{MPI} . \qquad EQ 1$$

FIG. 14B illustrates an alternate style of efficiency report 400 for a campaign 25 containing line entries 400A as may be generated by the efficiency engine 14. Such a report 400 will preferably include a campaign identifier 401 which may include a campaign code 401A and/or a campaign name 301B corresponding to a campaign identifier 70 and campaign name 72, respectively, in the campaign data records 25.

If applicable, the report entries 400A may include a location identifier 402 corresponding to a location identifier 84 in the location data records 35.

The report entries 400A will also preferably be provided with a segment identifier 404. Typically, the segment identifiers 404 will correspond to the segment identifiers 110, in the marketing program data records 33.

For each location 402, the report 400 may also include an entry 400A′ having a “All Products in Promotion” segment identifier 404 corresponding to efficiency calculations for all saleables 27 sold in association with at least one marketing program 23 (ie. for all saleables 27, 192 (or saleable 27, 102/location 35, 123 (or other distribution channel) combination) other than those indicating a “None” segment identifier 199 in the segmented measurables data records 39).

For each location 402, the report 400 may also include an entry 400A″ having an “All Products Not in Promotion” segment identifier 404 corresponding to efficiency calculations for all saleables 27 for which no marketing program 23 was used (ie. for all saleables 27, 192 (or saleable 27, 102/location 35, 123 combination) indicating a “None” segment identifier 199 in the segmented measurables data records 39).

As will be understood, for each different location 402, typically the report 400 will include one entry 400A corresponding to each marketing program segment 33, 199 listed on the segmented measurables data storage entity 32 (including the “None” segment 33′ and an “All Products in Promotion” segment).

Each entry 400A will preferably include sales data 406 corresponding to the segment 404 for the particular location 402. The sales data 406 is calculated by summing the sales data 194 for the campaign 190, 401A from each segmented measurables data record 39 in which the segment identifier 199 corresponds to the segment identifier 404 for the entry 400A (“None” in the case of “All Products Not in Promotion”). As will be understood, in the case of the “All Products in Promotion” entry 400A′, the sales data 406 is calculated by summing the sales data 194 for the campaign 190, 401A from each segmented measurables data record 39 in which the segment identifier 199 is not “None”.

Each entry 400A will preferably also include number of saleables data 408 corresponding to the segment 404 for the particular location 402. The number of saleables data 408 is calculated by totaling the number of different saleables 192 corresponding to the location 402, 193 for the campaign 190, 401A from each segmented measurables data record 39 in which the segment identifier 199 corresponds to the segment identifier 404 for the entry 400A (“None” in the case of “All Products Not in Promotion”). As will be understood, in the case of the “All Products in Promotion” entry 400A′, the number of saleables data 408 is calculated by totaling the number of different saleables 192 corresponding to the location 402, 193 for the campaign 190, 401A from each segmented measurables data record 39 in which the segment identifier 199 is not “None”.

Each entry 400A will preferably also be provided with sales % data 410 for the location 402 corresponding to the ratio of the sales value 406 of the segment 404 relative to the total of all sales 194 corresponding to the location 192, 402 in the segmented measurables data records 39 for the campaign 190, 401A. Alternatively, the total of all sales 194 may be calculated by adding the sales 406 values in the “All Products Not in Promotion” 400A″ and “All Products in Promotion” 400A′ entries.

Each entry 400A will preferably also be provided with number of saleables % data 412 for the location 402 corresponding to the ratio of the number of saleables 408 of the segment 404 relative to the total number of all saleables 27. In the example entry 400A″, it can be seen that since there was a total of “5” saleables 408 in the “All Products Not in Promotion” segment 404, and there were “14” saleables 27 in total, the number of saleables % data 412 is illustrated as “36%” (5/14=36%).

An efficiency value 414 is also provided. The efficiency value 414 for each entry 400A is calculated as the ratio of the sales % value 410 relative to the number of saleables % value 412 for that entry 400A. For example, referring to entry 400A′, the efficiency value 414 is listed as 121% (78%/64%=121%)

While the ROMI efficiency report 300 and alternate efficiency report 400 illustrate two different types of efficiency analyses which can be conducted on raw data 13 once the marketing programs have been segmented as described herein, it should be understood that other types of efficiency analyses can be performed. Furthermore, while various data entities and data have been illustrated and described herein, it should be understood that other structures for the entities and data may be created and used in accordance with the present invention.

Thus, while what is shown and described herein constitute preferred embodiments of the subject invention, it should be understood that various changes can be made without departing from the subject invention, the scope of which is defined in the appended claims.

1. A method of measuring the efficiency of a plurality of marketing programs for a campaign involving a plurality of saleables and at least one distribution channel, the steps of the method comprising:
(a) determining a plurality of marketing program segments, wherein each segment corresponds to a unique combination of marketing programs;
(b) uniquely correlating each combination of a saleable and distribution channel to a corresponding segment;
(c) determining the quantity of at least one measurable for each saleable; and
(d) calculating an efficiency value for at least one segment.

2. The method of claim 1, wherein the efficiency value is correlated to the total quantity of the at least one measurable for all combinations of a saleable and distribution channel correlated to the at least one segment.

3. The method of claim 2, wherein the efficiency value is further correlated to the total quantity of the at least one measurable for all combinations of a saleable and distribution channel.

4. The method of claim 3, wherein the efficiency value is correlated to the total number of combinations of a saleable and distribution channel correlated to the at least one segment.

5. The method of claim 4, wherein the efficiency value is further correlated to the total number of all combinations of a saleable and distribution channel.

6. The method of claim 1, wherein the marketing program segments include one non-marketing program segment corresponding to an absence of a marketing program.

7. The method of claim 1, wherein the at least one measurable corresponds to sales.

8. The method of claim 1, wherein the efficiency value corresponds to ROMI.

9. The method of claim 1, wherein step (b) further comprises determining a plurality of combinations of a saleable and a distribution channel in which the saleable is distributed through such distribution channel.

10. An efficiency report containing at least one efficiency value generated using the method of claim 1.

11. A system for measuring the efficiency of marketing programs, the system comprising:
(a) a data storage configured to store:
(i) marketing programs data comprising data corresponding to a plurality of marketing programs;
(ii) saleables data correlated to a plurality of saleables, wherein each saleable is correlated to at least one distribution channel and wherein at least one saleable is correlated to at least one marketing program; and
(iii) measurables data correlated to the value of at least one measurable for each saleable;
(b) a segmentor operatively coupled to the data storage and configured to determine a plurality of marketing program segments, wherein each segment corresponds to a unique combination of marketing programs and wherein the data storage is configured to store marketing program segment data correlated to the marketing program segments;
(c) a correlator operatively coupled to the data storage and configured to correlate each combination of a saleable and correlated distribution channel to one marketing program segment; and
(d) an efficiency calculator configured to calculate an efficiency value for at least one segment.

12. The system of claim 11, wherein the efficiency calculator is configured to correlate the efficiency value to the total quantity of the at least one measurable for all combinations of a saleable and distribution channel correlated to the at least one segment.

13. The system of claim 12, wherein the efficiency calculator is further configured to correlate the efficiency value to the total quantity of the at least one measurable for all combinations of a saleable and distribution channel.

14. The system of claim 13, wherein the efficiency calculator is further configured to correlate the efficiency value to the total number of combinations of a saleable and distribution channel correlated to the at least one segment.

15. The system of claim 14, wherein the efficiency calculator is further configured to correlate the efficiency value to the total number of all combinations of a saleable and distribution channel.

16. The system of claim 15, wherein the efficiency calculator is configured to calculate an efficiency value for each of a plurality of marketing program segments.

17. The system of claim 16, further comprising a reporting module configured to generate a report comprising at least one efficiency value.

18. The system of claim 11, wherein the at least one measurable corresponds to sales.

19. The system of claim 11, wherein the efficiency value corresponds to ROMI.

20. An efficiency report containing at least one efficiency value generated by the system as claimed in claim 11.
